(19) United States
(12) Patent Application Publication
(10) Pub. No.: US 2008/0238296 A1
(43) Pub. Date: Oct. 2, 2008

(54) ELECTRON-EMITTING DEVICE AND DISPLAY APPARATUS

(75) Inventors: Yutaka Nakai, Kanagawa (JP); Tomio Ono, Kanagawa (JP); Tadashi Sakai, Kanagawa (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 12/042,022

(22) Filed: Mar. 4, 2008

(30) Foreign Application Priority Data
Mar. 28, 2007 (JP) 2007-085982

(51) Int. Cl. H01J 1/62; H01J 1/02

(52) U.S. Cl. 313/500; 313/306

(57) ABSTRACT

An electron-emitting device includes a first electrode; an insulating film that is disposed on the first electrode, includes at least one step in an upper surface thereof, and includes a first surface on a lower step portion of the step and a second surface on an upper step portion of the step; a second electrode that is disposed on the first surface at a distance apart from the step; and a third electrode that is disposed on the second surface at a distance apart from the step.

### CROSS-REFERENCE TO RELATED APPLICATIONS

This application is based upon and claims the benefit of priority from the prior Japanese Patent Application No. 2007-085982, filed on Mar. 28, 2007; the entire contents of which are incorporated herein by reference.

### BACKGROUND OF THE INVENTION

1. Field of the Invention

The present invention relates to an electron-emitting device and a display apparatus that uses the electron-emitting device.

2. Description of the Related Art

Many methods have been suggested for an electron-emitting device that is used in a display apparatus. In a structure of the electron-emitting device called metal-insulator-metal (MIM) type that is used in one of the methods, a metal electrode, an insulating film, and another metal electrode are sequentially laminated. The MIM type electron-emitting device applies a voltage between the electrodes to emit electrons. In other words, the MIM type electron-emitting device uses a mechanism in which the electrons that are injected from one of the electrodes into the insulating film by the applied voltage are accelerated by an electric field between the electrodes and are emitted to outside after penetrating the other electrode. Although an anodized film formed of aluminum (Al) is widely used as the insulating film, various other film forming methods and structures are also used. Further, a metal, which is used in the electrode that is penetrated by the electrons, needs to be thin for facilitating easy penetration by the electrons. Thus, a thickness of the electrode is generally between several nanometers (nm) and several tens of nm.

However, because most of the accelerated electrons lose energy inside the electrode, only a small number of the electrons are emitted after penetrating the electrode. Electron emission efficiency is defined as a ratio of an electric current (a number of the electrons that flow into the electrode without getting emitted) that is generated due to the electrons that flow into the electrode without getting emitted and an electric current (a number of the electrons that are emitted from the electrode and reach another electrode at an emission destination) that is generated due to the electrons that are emitted from the electrode and reach the other electrode at the emission destination. In the normal MIM type electron-emitting device, the electron emission efficiency is approximately 3 percent even if the most expensive elements are used. Thus, a salient feature of the MIM type electron-emitting device is inadequate. Further, because the electron emission efficiency is largely dependent on a film thickness of the electrode that is penetrated by the electrodes, the film thickness needs to be strictly controlled. Due to this, high quality manufacturing becomes difficult.

To overcome the drawback, in a method that is suggested in JP-A 2000-251618 (KOKAI), a minute aperture (opening) is formed on the electrode that is penetrated by the electrons and the electron emission efficiency is enhanced by emitting the electrons from the minute aperture.

However, in the method mentioned earlier, because an equipotential surface at the opening is distributed such that the equipotential surface extends towards the outer side of the electron-emitting device, an electric field intensity of the opening is reduced. Due to this, electron emission from the opening decreases. To overcome the drawback, relatively reducing a size of the opening enables to reduce electric field intensity reduction at the opening. However, for ensuring uniform electron emission efficiency, the opening needs to be minutely processed using high precision and uniformity. Thus, manufacturing the electrode becomes difficult.

### SUMMARY OF THE INVENTION

According to one aspect of the present invention, an electron-emitting device includes a first electrode; an insulating film that is disposed on the first electrode, includes at least one step in an upper surface thereof, and includes a first surface on a lower step portion of the step and a second surface on an upper step portion of the step; a second electrode that is disposed on the first surface at a distance apart from the step; and a third electrode that is disposed on the second surface at a distance apart from the step.

According to another aspect of the present invention, an electron-emitting device includes a substrate; a first electrode that is disposed on the substrate; a second electrode that is disposed on the substrate in a different area where the first electrode is disposed on the substrate; an insulating film that is disposed on the first electrode; and a third electrode that is disposed on the insulating film, wherein the third electrode is disposed at an inner side from an end of an upper surface of the insulating film and the upper surface of the insulating film of the end is exposed.

According to still another aspect of the present invention, a display apparatus includes an electron-emitting device that emits electrons; a scan line and a data line that transmit input image signals to the electron-emitting device; and a transparent substrate that is positioned opposite to the electron-emitting device at a predetermined distance apart therefrom, and provides a fluorescent material on a surface thereof, wherein the electron-emitting device includes a first electrode, an insulating film that is formed on the first electrode, includes at least one step in an upper surface, and includes a first surface on a lower step portion and a second surface on an upper step portion of the step, a second electrode that is formed on the first surface at a distance apart from the step, and a third electrode that is formed on the second surface at a distance apart from the step.

According to still another aspect of the present invention, a display apparatus includes an electron-emitting device that emits electrons; a scan line and a data line that transmit input image signals to the electron-emitting device; and a transparent substrate that is positioned opposite to the electron-emitting device at a predetermined distance apart therefrom, and provides a fluorescent material on a surface thereof, wherein the electron-emitting device includes a substrate, a first electrode that is disposed on the substrate, a second electrode that is disposed on the substrate in a different area where the first electrode is disposed on the substrate, an insulating film that is disposed on the first electrode, and a third electrode that is disposed on the insulating film, wherein the third electrode is disposed at an inner side from an end of an upper surface of the insulating film and the upper surface of the insulating film of the end is exposed.

### BRIEF DESCRIPTION OF THE DRAWINGS

FIG. 1A is a top view illustrating an electron-emitting device according to a first embodiment of, the present invention;

FIG. 1B is a side sectional view illustrating an electron-emitting device according to the first embodiment;

FIG. 2A is a top view illustrating an electron-emitting device according to a comparative example;

FIG. 2B is a side sectional view illustrating an electron-emitting device according to a comparative example;

FIGS. 3A to 3D are schematic views for explaining a relation between a shape of the electron-emitting device and electric field intensity;

FIG. 4A is a top view illustrating an electron-emitting device according to a second embodiment of the present invention;

FIG. 4B is a side sectional view illustrating an electron-emitting device according to the second embodiment;

FIG. 5A is a top view illustrating an electron-emitting device according to a third embodiment of the present invention;

FIG. 5B is a side sectional view illustrating an electron-emitting device according to the third embodiment;

FIG. 6A is a top view illustrating an example of a display apparatus that uses the electron-emitting device according to the third embodiment;

FIG. 6B is a sectional view along line A-A in FIG. 6A;

FIG. 7 is a schematic view illustrating an example of a display apparatus in which display devices are arranged in a matrix manner;

FIG. 8 is a side sectional view illustrating an example of a glow discharge-optical emission device that uses the electron-emitting device according to the first embodiment; and

FIG. 9 is a side sectional view illustrating an example of an X-ray emitting device that uses the electron-emitting device according to the first embodiment.

### DETAILED DESCRIPTION OF THE INVENTION

Exemplary embodiments of the electron-emitting device and the display apparatus according to the present invention are explained below with reference to the accompanying drawings. For the sake of convenience, various members are described using different reduction scales in the schematic views that are indicated below.

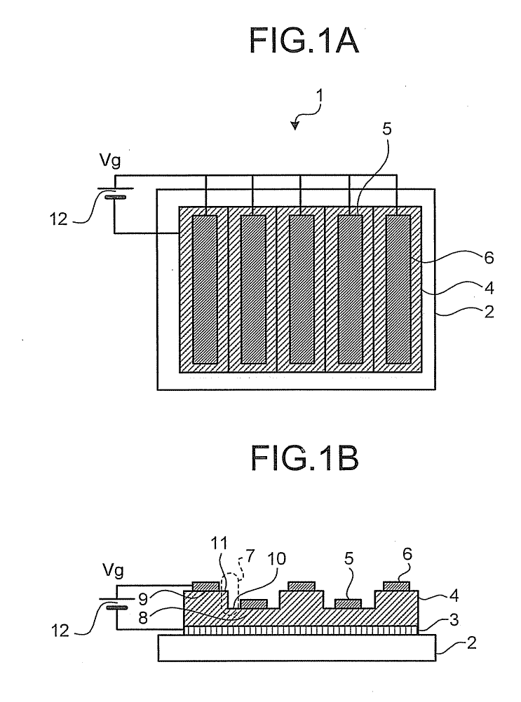

A first embodiment of the present invention is explained with reference to the accompanying drawings. As shown in FIGS. 1A and 1B, an electron-emitting device 1 includes a substrate 2, a first electrode 3, an insulating film 4, a second electrode 5, and a third electrode 6. The substrate 2 is formed of glass or silicon. The first electrode 3, which is formed on the substrate 2, injects electrons into the insulating film 4. Although any material such as a metal or a semiconductor which is a highly electron emitting conductive material can be used for the first electrode 3, in the first embodiment, the first electrode 3 is formed of aluminium (Al).

The insulating film 4 is formed on the first electrode 3. The insulating film 4 includes a step 7, a lower step surface 8, and an upper step surface 9. The step 7, which is formed in the insulating film 4, includes a lower exposed portion 10 and an upper exposed portion 11. The second electrode 5 is not formed on the lower exposed portion 10 that is a lower portion of the step 7, thus exposing the insulating film 4 to outside. The third electrode 6 is not formed on the upper exposed portion 11 that is an upper portion of the step 7, thus exposing the insulating film 4 to the outside. The lower step surface 8 is on the same level as the lower exposed portion 10 and the upper step surface 9 is on the same level as the upper exposed portion 11. Any insulating material can be used for the insulating film 4. In the present embodiment, the insulating film 4 is formed of silicon oxide (SiOx).

The second electrode 5 is formed on the lower step surface 8 of the insulating film 4. Thus, the second electrode 5 is not formed on the lower exposed portion 10 of the insulating film 4. The third electrode 6 is formed on the upper step surface 9 of the insulating film 4. Thus, the third electrode 6 is not formed on the upper exposed portion 11 of the insulating film 4. Accordingly, the step 7 of the insulating film 4 includes openings where the second electrode 5 and the third electrode 6 are not formed and the insulating film 4 is exposed to the outside. Although any metal or a semiconductor which is a conductive material can be used for the second electrode 5 and the third electrode 6, in the first embodiment, the second electrode 5 and the third electrode 6 are formed of gold (Au).

A mechanism used by the electron-emitting device 1 to emit the electrons is explained next. A power source 12 is connected between the first electrode 3, and the second electrode 5 and the third electrode 6. Upon applying a voltage Vg, electrons are injected from the first electrode 3 into the insulating film 4. Inside the insulating film 4, the electrons are accelerated by an electric field between the first electrode 3, and the second electrode 5 and the third electrode 6. The accelerated electrons are emitted from the second electrode 5, the third electrode 6, the lower exposed portion 10, and the upper exposed portion 11.

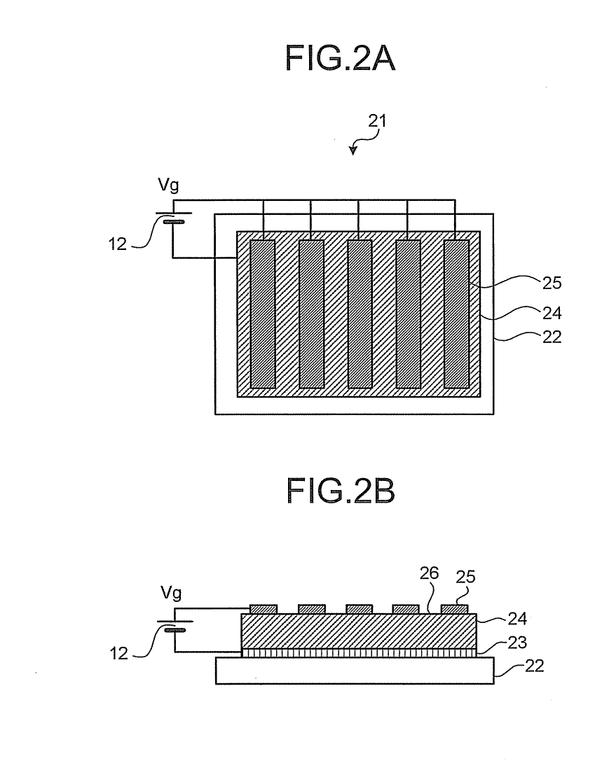

A salient feature of the structure of the electron-emitting device 1 mentioned earlier is explained next by comparing the electron-emitting device 1 to an electron-emitting device shown in FIGS. 2A and 2B. As shown in FIGS. 2A and 2B, an electron-emitting device 21 which is used as a comparative example, includes a substrate 22, a first electrode 23, an insulating film 24, and a second electrode 25. The first electrode 23, which is formed on the substrate 22, injects the electrons into the insulating film 24. The insulating film 24 is formed on the first electrode 23. The insulating film 24, which does not include a step such as the step 7 of the electron-emitting device 1 according to the first embodiment, is evenly shaped.

Although the second electrode 25 is formed on the insulating film 24, the second electrode 25 does not entirely cover the insulating film 24. The upper surface of the insulating film 24 is exposed to the outside at an exposed portion 26 that is included in the insulating film 24. Accordingly, the second electrode 25 is not formed on the exposed portion 26 of the insulating film 24, thus forming an opening. Materials which are used for the substrate 22, the first electrode 23, the insulating film 24, and the second electrode 25 are the same as the materials that are used for the substrate 2, the first electrode 3, the insulating film 4, and the second electrode 5 respectively. The power source 12 is connected between the first electrode 23 and the second electrode 25. Upon applying the voltage Vg, the electrons are emitted from the second electrode 25 and the exposed portion 26.

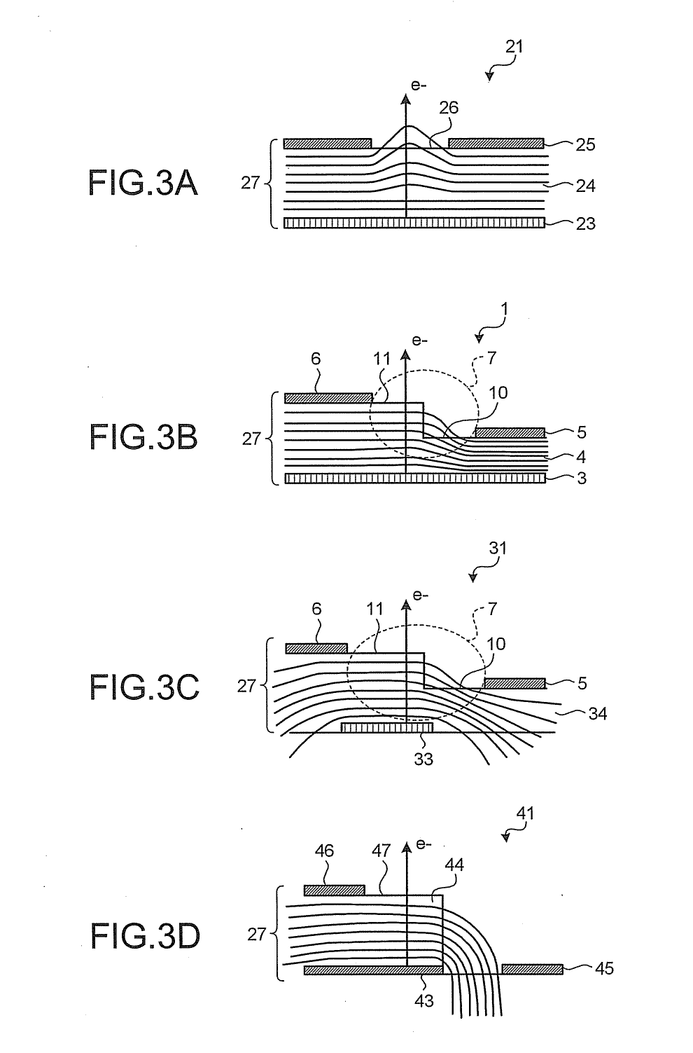

An equipotential surface 27 shown in FIGS. 3A to 3D indicates a surface having a fixed potential when a voltage is applied between electrodes. An arrow shown in FIGS. 3A to 3D indicates a direction of emission of the electrons. The electrons are emitted from an electrode by penetrating the electrode and the electrons are also emitted from the opening (the exposed portion 26 of the insulating film 24) of the electrode. However, only the electrons, which are emitted from the opening of the electrode, are considered in the example shown in FIGS. 3A to 3D.

FIG. 3A is a schematic view for explaining an electric potential distribution in the vicinity of the opening (the exposed portion 26) when the voltage Vg is applied between the first electrode 23 and the second electrode 25 of the electron-emitting device 21. As shown in FIG. 3A, the equipotential surface 27 exudes and extends from the exposed portion 26 of the second electrode 25 towards the outer side of the electron-emitting device 21. Extending of the equipotential surface 27 can be easily calculated using an electric field calculation. If the equipotential surface 27 extends towards the outer side of the electron-emitting device 21, an electric field intensity of a surface of the insulating film 24 at the exposed portion 26 decreases. Due to this, an acceleration that is added to the electrons is reduced and a number of the electrons emitted from the exposed portion 26 are also reduced, thus reducing electron emission efficiency.

FIG. 3B is a schematic view for explaining the electric potential distribution in the vicinity of the step 7 when the voltage Vg is applied between the first electrode 3, and the second electrode 5 and the third electrode 6 in the electron-emitting device 1 according to the first embodiment. A distance between the first electrode 3 and the third electrode 6 is the same as the distance between the first electrode 23 and the second electrode 25 in the electron-emitting device 21 that is used as the comparative example.

As shown in FIG. 3B, the second electrode 5 is positioned nearer to the first electrode 3 than the third electrode 6. In other words, the second electrode 5 has moved in an opposite direction of the direction in which the equipotential surface 27 extends in the electron-emitting device 21 that is used as the comparative example. Thus, moving the second electrode 5 in the opposite direction effectively curbs the extending of the equipotential surface 27 from the openings (a portion that includes the lower exposed portion 10 and the upper exposed portion 11) between the second electrode 5 and the third electrode 6 towards the outer side of the electron-emitting device 1. The resulting equipotential surface 27 due to such a curbing is shown in FIG. 3B.

Due to this, the electric field intensity of the surface of the insulating film 4 at the opening of the third electrode 6 (the upper exposed portion 11) does not decrease and the acceleration that is added to the electrons does not change from the acceleration in the portion that includes the third electrode 6. Thus, the number of the electrons which are emitted from the upper exposed portion 11 increases compared to the number of the electrons emitted from the electron-emitting device 21 that is used as the comparative example and the electron emission efficiency is enhanced.

Accordingly, depending on the required electron emission efficiency, a necessity to emit the electrons by penetrating the second electrode 5 and the third electrode 6 is also removed. Thus, a film thickness of the second electrode 5 and a film thickness of the third electrode 6 can be increased, thereby simplifying a manufacturing process.

The electrons are also emitted from the lower exposed portion 10. However, because the electrons are emitted in a perpendicular direction to the equipotential surface 27, the electrons emitted from the lower exposed portion 10 move towards a right side with respect to the direction of the arrow that is shown in FIG. 3B. Thus, whether the electrons emitted from the lower exposed portion 10 are contributing to enhance the electron emission efficiency is decided based on a distance, a range etc. that are necessary for reaching of the electrons.

A manufacturing example of the electron-emitting device 1 is explained next with reference to FIGS. 1A and 1B. A film of 100 nm of Al is formed on the washed glass substrate 2 by sputtering to form the first electrode 3. Next, a film of 300 nm of SiOx is formed as the insulating film 4. Approximately 150 nm of SiOx is removed in a slit shape using reactive ion etching (RIE) to form the step 7 (the lower step surface 8, the lower exposed portion 10, the upper step surface 9, and the upper exposed portion 11). Next, a film of 50 nm of Au is formed by sputtering to pattern the second electrode 5 and the third electrode 6. Finally, upon connecting the power source 12 to an end of the first electrode 3, and ends of the second electrode 5 and the third electrode 6, the voltage Vg can be easily applied to each electrode.

In the manufacturing example mentioned earlier, because a gold film having the film thickness of 50 nm is used, the electrons which reach the second electrode 5 and the third electrode 6 flow into the electrodes and do not get emitted from the second electrode 5 and the third electrode 6 by penetrating the electrodes. However, because the electrons are emitted from the opening (the upper exposed portion 11) of the third electrode 6 with high efficiency, even if an electron emission path that penetrates the second electrode 5 and the third electrode 6 is blocked by increasing the film thickness of the second electrode 5 and the third electrode 6, the electron emission efficiency of the entire electron-emitting device 1 is not affected. Setting the film thickness of the gold film to 50 nm enables to get a sufficient film thickness distribution in manufacturing, thus enhancing uniformity of an electron emitting characteristic. The electron emission path which penetrates the second electrode 5 and the third electrode 6 can also be secured by setting the film thickness of the gold film to less than or equal to 10 nm.

The electron emission efficiency also fluctuates according to a level difference (depth) of the step 7, the slit shapes of the second electrode 5 and the third electrode 6, relative positions of the second electrode 5, the third electrode 6, and the step 7 etc. However, the electron emission efficiency is within a range that can be controlled using a normal minute processing and using a special manufacturing process is not needed.

The electron-emitting device 1 which is manufactured under the conditions mentioned earlier is placed under a vacuum of 1×10⁻⁵ Torr and the voltage Vg is applied between the first electrode 3, and the second electrode 5 and the third electrode 6 using the power source 12 to evaluate the electron emitting characteristics. To be specific, a substrate, which is formed using an indium tin oxide (ITO) film, is positioned opposite the electron-emitting device 1, a high voltage is applied between the electron-emitting device 1 and the opposite substrate, and an emitted current Ia is measured. The emitted current Ia of 10 milliamperes per square centimeter (mA/cm²) is obtained upon applying the voltage Vg of 100 volts (V) and the electron emission efficiency is 3 percent.

Thus, for simplifying the manufacturing process of the electron-emitting device 1, even if the film thickness of the second electrode 5 and the third electrode 6 is increased and the electron emission using penetration of the second electrode 5 and the third electrode 6 is stopped, the electron emission efficiency that can be reached is the same as the highest electron efficiency obtained by using a commonly used electron-emitting device.

Thus, in the electron-emitting device according to the first embodiment, a step is formed in an insulating film and openings of electrodes are formed on the step. Due to this, the acceleration that is added to the electrons can be strengthened without reducing the electric field intensity of the openings. Thus, the number of the electrons that are emitted from the openings increases and the electron emission efficiency can be enhanced.

Further, in the electron-emitting device according to the first embodiment, emitting the electrons from the electrodes formed on an upper surface of the insulating film is not necessitated. Thus, the film thickness of the electrodes can be increased and the manufacturing process of the electron-emitting device is simplified.

In a second embodiment of the present invention, a first electrode is formed such that the first electrode corresponds to a portion that includes the opening (an upper exposed portion of the step of the insulating film) of a third electrode. The second embodiment is explained with reference to the accompanying drawings. When explaining a structure of the electron-emitting device according to the second embodiment, only the portions that differ from the respective portions in the first embodiment are explained. Because the other portions of the structure are similar to the respective portions in the first embodiment, for the portions indicated by the same codes, the explanation mentioned earlier is to be referred and an explanation in the second embodiment is omitted.

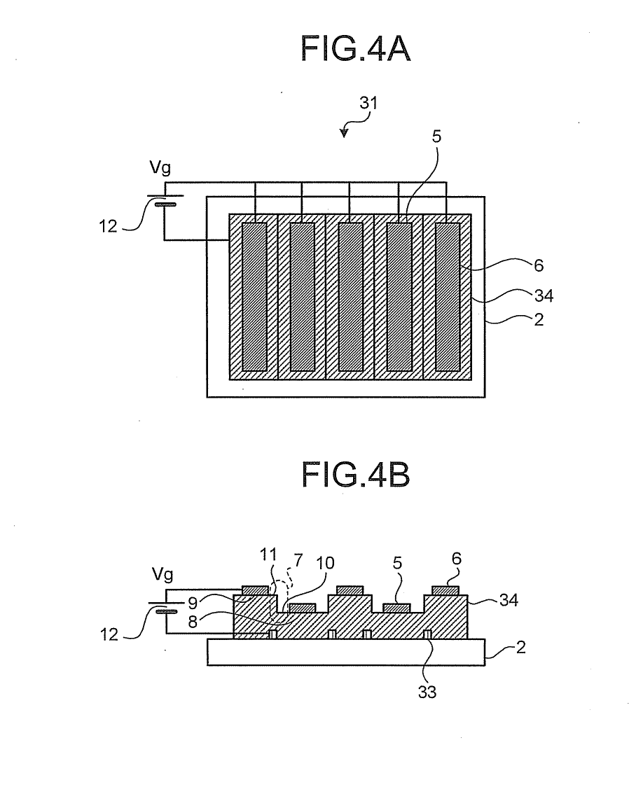

As shown in FIGS. 4A and 4B, an electron-emitting device 31 includes the substrate 2, a first electrode 33, an insulating film 34, the second electrode 5, and the third electrode 6.

The first electrode 33, which is formed on the substrate 2, injects the electrons into the insulating film 34. To be specific, the first electrode 33 is formed in a portion on the lower side of the insulating film 34 that corresponds to a portion that includes the upper exposed portion 11. The first electrode 33 is not formed in any other portion. Although a metal or a semiconductor which is a highly electron emitting conductive material can be used for the first electrode 33, in the second embodiment, the first electrode 33 is formed of Al.

The insulating film 34 is formed on the substrate 2 and the first electrode 33. The insulating film 34 includes the step 7, the lower step surface 8, and the upper step surface 9. The step 7 further includes the lower exposed portion 10 and the upper exposed portion 11. Any insulating material can be used for the insulating film 34. However, in the second embodiment, the insulating film 34 is formed of SiOx.

A mechanism used by the electron-emitting device 31 to emit the electrons is explained next. The power supply 12 is connected between the first electrode 33, and the second electrode 5 and the third electrode 6. Upon applying the voltage Vg, the electrons are injected into the insulating film 34 from the first electrode 33. Inside the insulating film 34, the electrons are accelerated by the electric field between the first electrode 33, and the second electrode 5 and the third electrode 6. The accelerated electrons are emitted from the upper exposed portion 11.

A salient feature of the structure of the electron-emitting device 31 mentioned earlier is explained next with reference to FIGS. 3A to 3D. As shown in FIG. 3B, in the structure of the electron-emitting device 1 according to the first embodiment, because an interval between the first electrode 3 and the second electrode 5 is less than an interval between the first electrode 3 and the third electrode 6, the electric field intensity between the first electrode 3 and the second electrode 5 is greater than the electric field intensity between the first electrode 3 and the third electrode 6. Due to this, most of the electrons flow from the first electrode 3 to the second electrode 5 via the insulating film 4, thus hampering enhancement of the electron emission efficiency.

FIG. 3C is a schematic view for explaining the electric potential distribution in the vicinity of the step 7 when the voltage Vg is applied between the first electrode 33, and the second electrode 5 and the third electrode 6 in the electron-emitting device 31 according to the second embodiment.

In the electron-emitting device 31, only a voltage needs to be applied between the first electrode 33 and the second electrode 5 and a flow of the electrons from the first electrode 33 to the second electrode 5 is not indispensable. Due to this, to prevent the flow of the electrons from the first electrode 33 to the second electrode 5 via the insulating film 34, the first electrode 33 is not formed on the lower side of the second electrode 5 (the first electrode 33 is openly shaped).

Further, in the electron-emitting device 31, only a voltage needs to be applied between the first electrode 33 and the third electrode 6 and a flow of the electrons from the first electrode 33 to the third electrode 6 is not indispensable. Due to this, to prevent the flow of the electrons from the first electrode 33 to the third electrode 6 via the insulating film 34, the first electrode 33 is also not formed on the lower side of the third electrode 6 (the first electrode 33 is openly shaped).

Further, similarly as explained in the first embodiment, the first electrode 33 in the electron-emitting device 31 is also not formed on the lower side of the lower exposed portion 10 to prevent the emission of the electrons that move from the lower exposed portion 10 towards the right side with respect to the direction of the arrow that is shown in FIG. 3C (the first electrode 33 is openly shaped). By using the structure mentioned earlier, the equipotential surface 27 does not extend towards the outer side of the electron-emitting device 31. Due to this, the electric field intensity of the surface of the insulating film 34 at the opening of the third electrode 6 (the upper exposed portion 11) is not reduced and the acceleration that is added to the electrons does not change compared to the electron-emitting device 1 according to the first embodiment.

Further, by using the structure mentioned earlier, the number of the electrons that flow from the first electrode 33 to the second electrode 5 via the insulating film 34 is reduced and the number of the electrons that flow from the first electrode 33 to the third electrode 6 via the insulating film 34 is also reduced, thereby increasing a percentage of the number of the electrons that are emitted from the upper exposed portion 11 with respect to the number of the electrons, from all the electrons that are injected into the insulating film 34 from the first electrode 33, that flow into the second electrode 5 or the third electrode 6. Thus, the electron emission efficiency is further enhanced compared to the electron emission efficiency of the electron-emitting device 1 according to the first embodiment.

Further, the structure of the electron-emitting device 31 does not include a portion where the first electrode 33 and the second electrode 5 overlap with each other or a portion where the first electrode 33 and the third electrode 6 overlap with each other (portions of the first electrode 33 corresponding to the second electrode 5 and the third electrode 6 are open). Due to this, a capacitance between the first electrode 33 and the second electrode 5 and a capacitance between the first electrode 33 and the third electrode 6 are significantly reduced. Because a significant reduction in the capacitance indicates a significant reduction in a load capacity for an electron source-driving unit, the structure of the electron-emitting device 31 is effective when driving a plurality of electron-emitting devices, for example, when applying the electron-emitting devices to a display apparatus.

A manufacturing example of the electron-emitting device 31 is explained with reference to FIGS. 4A and 4B. A film of 100 nm of Al is formed on the washed glass substrate 2 by sputtering and the film is patterned into a slit shape to form the first electrode 33. Next, a film of 300 nm of SiOx is formed as the insulating film 34. Approximately 150 nm of SiOx is removed in the slit shape using the RIE to form the step 7 (the lower step surface 8, the upper step surface 9, the lower exposed portion 10, and the upper exposed portion 11). Next, a film of 50 nm of Au is formed by sputtering to pattern the second electrode 5 and the third electrode 6. Finally, upon connecting the power source 12 to the end of the slit shaped first electrode 3 and to the ends of the slit shaped second electrode 5 and the third electrode 6, the voltage Vg can be easily applied to each electrode.

In the manufacturing example mentioned earlier, because the gold film having the film thickness of 50 nm is used, the electrons which reach the second electrode 5 and the third electrode 6 flow into the electrodes and do not get emitted from the second electrode 5 and the third electrode 6 by penetrating the electrodes. However, because the electrons are emitted from the opening (the upper exposed portion 11) of the third electrode 6 with high efficiency, even if the electron emission path that penetrates the second electrode 5 and the third electrode 6 is blocked by increasing the film thickness of the second electrode 5 and the third electrode 6, the electron emission efficiency of the entire electron-emitting device 31 is not affected. Setting the film thickness of the gold film to 50 nm enables to get the sufficient film thickness distribution in the manufacturing process, thus enhancing the uniformity of the electron emitting characteristic. The electron emission path which penetrates the second electrode 5 and the third electrode 6 can also be secured by setting the film thickness of the gold film to less than or equal to 10 nm.

The electron emission efficiency also fluctuates according to the level difference (depth) of the step 7, the slit shapes of the second electrode 5 and the third electrode 6, relative positions of the second electrode 5 and the third electrode 6 with respect to the step 7 etc. However, the electron emission efficiency is within the range that can be controlled using the normal minute processing and using a special manufacturing process is not needed.

The electron-emitting device 31 which is manufactured under the conditions mentioned earlier is placed under the vacuum of 1×10⁻⁵ Torr and the voltage Vg is applied between the first electrode 33, and the second electrode 5 and the third electrode 6 using the power source 12 to evaluate the electron emitting characteristic. To be specific, the substrate, which is formed using the ITO film, is positioned opposite the electron-emitting device 31, a high voltage is applied between the electron-emitting device 31 and the opposite substrate, and the emitted current Ia is measured. The emitted current Ia of 10 mA/cm² is obtained upon applying the voltage Vg of 100V and the electron emission efficiency is 6 percent. Thus, the electron emission efficiency is twice the electron emission efficiency of the electron-emitting device 1 according to the first embodiment.

Further, in the manufacturing example mentioned earlier, the structure of the electron-emitting device 31 does not include a portion where the first electrode 33 and the second electrode 5 overlap with each other or a portion where the first electrode 33 and the third electrode 6 overlap with each other (portions of the first electrode 33 corresponding to the second electrode 5 and the third electrode 6 are open). Due to this, the capacitance between the first electrode 33 and the second electrode 5 and the capacitance between the first electrode 33 and the third electrode 6 are significantly reduced.

In the electron-emitting device according to the second embodiment, electrode portions that are formed on the lower surface of the insulating film and that correspond to the electrode portions formed on the upper surface of the insulating film are all removed. Due to this, the number of the electrons, which flow from the electrode on the lower surface to the electrodes on the upper surface, can be reduced and the percentage of the number of the electrons that are emitted from electrode openings increases. Thus, the electron emission efficiency can be enhanced.

Further, in the electron-emitting device according to the second embodiment, the electrode portions that are formed on the lower surface of the insulating film and that correspond to the exposed portions of the insulating film on the lower surface of the step are all removed. Due to this, from the electrons that are emitted from the electrode openings, emission of the electrons that are not emitted perpendicularly and that do not reach an electrode at an emission destination can be prevented, thus enhancing the electron emission efficiency.

Further, in the electron-emitting device according to the second embodiment, the electrodes formed on the upper surface of the insulating film do not overlap with the electrode that is formed on the lower surface of the insulating film. Due to this, the capacitance between the electrodes can be significantly reduced.

In a third embodiment of the present invention, the insulating film and the third electrode are formed on the first electrode and the second electrode is formed on the same surface as the first electrode. The third embodiment is explained with reference to the accompanying drawings. When explaining a structure of the electron-emitting device according to the third embodiment, only the portions that differ from the respective portions in the first embodiment are explained. Because the other portions of the structure are similar to the respective portions in the first embodiment, for the portions indicated by the same codes, the explanation mentioned earlier is to be referred and an explanation in the third embodiment is omitted.

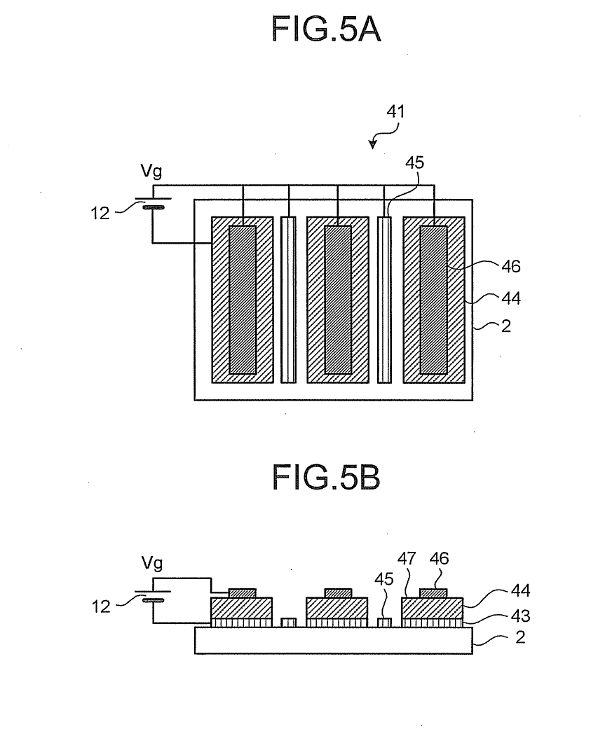

As shown in FIGS. 5A and 5B, an electron-emitting device 41 includes the substrate 2, a first electrode 43, an insulating film 44, a second electrode 45, and a third electrode 46.

The first electrode 43, which is formed on the substrate 2, injects the electrons into the insulating film 44. The first electrode 43 is slit shaped. Although any material such as a metal or a semiconductor which is a highly electron emitting conductive material can be used for the first electrode 43, in the third embodiment, the first electrode 43 is formed of Al.

The insulating film 44 is formed on the first electrode 43. Any insulating material can be used for the insulating film 44. However, in the third embodiment, the insulating film 44 is formed of SiOx.

The second electrode 45 is formed on the substrate 2. Thus, the first electrode 43 and the second electrode 45 are formed on the same substrate 2. To be specific, the second electrode 45 is slit shaped and is disposed parallel to the first electrode 43. Although any conductive material such as a metal or a semiconductor can be used for the second electrode 45, in the third embodiment, the second electrode 45 is formed of Al.

The third electrode 46 is formed on the insulating film 44. The third electrode 46 is not formed in the vicinity of the ends of the insulating film 44 and an area of the third electrode 46 is marginally less than an area of the insulating film 44. Due to this, the insulating film 44 includes an exposed portion 47 on the upper surface that is exposed to the outside. Although any metal or a semiconductor, which is a conductive material, can be used for the third electrode 46, in the third embodiment, the third electrode 46 is formed of Au.

A mechanism used by the electron-emitting device 41 to emit the electrons is explained next. The power source 12 is connected between the first electrode 43, and the second electrode 45 and the third electrode 46. Upon applying the voltage Vg, the electrons are injected into the insulating film 44 from the first electrode 43. Inside the insulating film 44, the electrons are accelerated by the electric field between the first electrode 43 and the third electrode 46 (the second electrode 45). The accelerated electrons are emitted from the third electrode 46 and the exposed portion 47.

A salient feature of the structure of the electron-emitting device 41 mentioned earlier is explained next with reference to FIGS. 3A to 3D. FIG. 3D is a schematic view for explaining the electric potential distribution in the vicinity of the exposed portion 47 when the voltage Vg is applied between the first electrode 43, and the second electrode 45 and the third electrode 46 in the electron-emitting device 41 according to the third embodiment.

In the electron-emitting device 41 according to the third embodiment, although the first electrode 43 and the second electrode 45 are formed on the same layer, similarly as the electron-emitting device 1 according to the first embodiment and the electron-emitting device 31 according to the second embodiment, the equipotential surface 27 does not extend to the outside of the electron-emitting device 41. Due to this, the electric field intensity of the surface of the insulating film 44 at the opening of the third electrode 46 (the exposed portion 47) is not reduced and the acceleration that is added to the electrons does not change compared to the electron-emitting device 1 according to the first embodiment.

Further, because the distance between the first electrode 43 and the second electrode 45 is separated compared to the distance between the first electrode 43 and the third electrode 46, the electrons do not flow from the first electrode 43 to the second electrode 45, thus increasing the percentage of the number of the electrons that are emitted from the exposed portion 47 with respect to the number of the electrons, from all the electrons that are injected from the first electrode 43 into the insulating film 44, that flow into the third electrode 46 without getting emitted. Thus, the electron emission efficiency is further enhanced compared to the electron-emitting device 1 according to the first embodiment.

Further, because a necessity to include the step in the insulating film 44 is removed, the manufacturing process is simplified compared to the electron-emitting device 31 according to the second embodiment.

A manufacturing example of the electron-emitting device 41 is explained with reference to FIGS. 5A and 5B. A film of 100 nm of Al is formed on the washed glass substrate 2 by sputtering, the film is patterned into a slit shape to form the first electrode 43, and the second electrode 45 is simultaneously disposed on both the sides of the first electrode 43. Next, a film of 300 nm of SiOx is formed and SiOx is selectively removed by the RIE in a slit shape to dispose the insulating film 44. As shown in FIGS. 5A and 5B, the insulating film 44 is formed in the same shape as the shape of the first electrode 43. However, the insulating film 44 can also be formed such that the first electrode 43 is coated by the insulating film 44, or the insulating film 44 can also be patterned such that a periphery of the first electrode 43 is exposed. Next, a film of 50 nm of Au is formed by sputtering and patterned into the third electrode 46. The power source 12 is connected to the end of the slit shaped first electrode 43 and to the ends of the slit shaped second electrode 45 and the third electrode 46. Thus, the voltage Vg can be easily applied to each electrode.

In the manufacturing example mentioned earlier, because the gold film having the film thickness of 50 nm is used, the electrons, which reach the third electrode 46, flow into the electrode and do not get emitted from the third electrode 46 by penetrating the electrode. However, because the electrons are emitted from the opening (the exposed portion 47) of the third electrode 46 with high efficiency, even if the electron emission path that penetrates the third electrode 46 is blocked by increasing the film thickness of the third electrode 46, the electron emission efficiency of the entire electron-emitting device 41 is not affected. Setting the film thickness of gold to 50 nm enables to get the sufficient film thickness distribution in the manufacturing process, thus enhancing the uniformity of the electron emitting characteristic. The electron emission path which penetrates the third electrode 46 can also be secured by setting the film thickness of gold to less than or equal to 10 nm.

The electron emission efficiency also fluctuates according to the slit shape of the third electrode 46, the relative position of the third electrode 46 with respect to the first electrode 43 and the second electrode 45 etc. However, the electron emission efficiency is within the range that can be controlled using the normal minute processing and using a special manufacturing process is not needed.

The electron-emitting device 41 which is manufactured under the conditions mentioned earlier is placed under the vacuum of 1×10⁻⁵ Torr and the voltage Vg is applied between the first electrode 43, and the second electrode 45 and the third electrode 46 using the power source 12 to evaluate the electron emitting characteristic. To be specific, the substrate, which is formed using the ITO film, is positioned opposite the electron-emitting device 41, a high voltage is applied between the electron-emitting device 41 and the opposite board, and the emitted current Ia is measured. The emitted current Ia of 10 mA/cm² is obtained upon applying the voltage Vg of 100V and the electron emission efficiency is 6 percent. Thus, the electron emission efficiency is the same as the electron emission efficiency of the electron-emitting device 31 according to the second embodiment.

In the third embodiment, the second electrode 45 is formed by using the same process that is used to form the first electrode 43. However, the second electrode 45 can also be formed by using the same process that is used to form the third electrode 46. Further, the second electrode 45 can also be formed by using a process that is different from forming processes of the first electrode 43 and the third electrode 46.

In the electron-emitting device according to the third embodiment, the electrode, which injects the electrons into the insulating film, and a portion of another electrode that generates the electric field with the electrode are formed on the same surface. Due to this, the acceleration that is added to the electrons can be increased without reducing the electric field intensity of the exposed portion of the insulating film. Thus, the number of the electrons that are emitted from the opening increases and the electron emission efficiency can be enhanced.

Further, in the electron-emitting device according to the third embodiment, the electrode, which injects the electrons into the insulating film, is separated from the portion of the other electrode that generates the electric field with the electrode. Due to this, the electrons do not flow between the electrodes, thus increasing the percentage of the electrons that are emitted from the exposed portion of the insulating film. Thus, the electron emission efficiency can be enhanced.

Further, in the electron-emitting device according to the third embodiment, a necessity to include the step in the insulating film is removed. Thus, a process, which uses the RIE to include the step in the insulating film, is not required and the manufacturing process of the electron-emitting device is simplified.

A fourth embodiment of the present invention is explained next with reference to the accompanying drawings. In the fourth embodiment, the electron-emitting device according to the third embodiment is applied to a display apparatus.

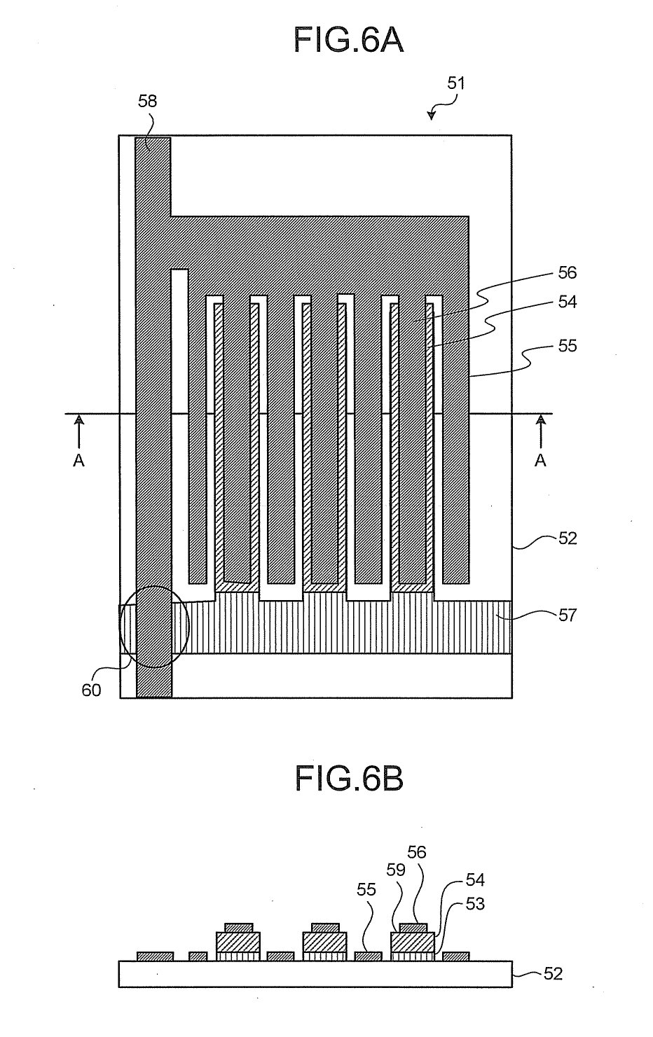

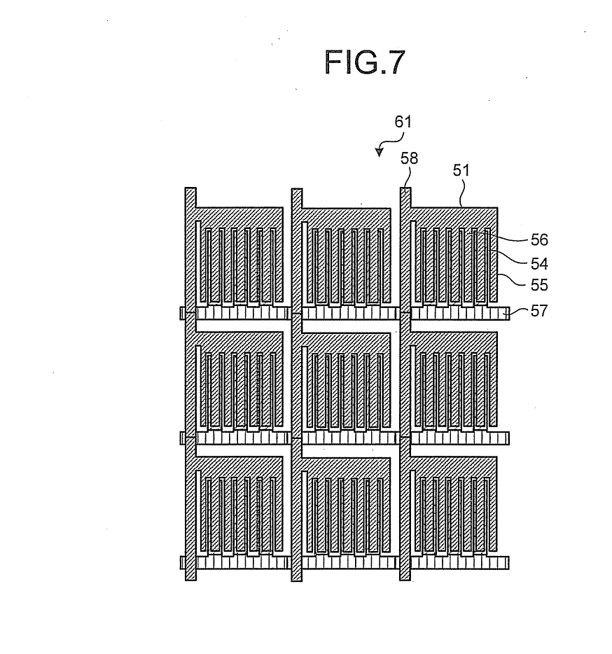

As shown in FIGS. 6A to 7, a display device 51 displays an image according to input image signals. The display device 51 includes a substrate 52, a first electrode 53, an insulating film 54, a second electrode 55, a third electrode 56, a scan line 57, a data line 58, and a not shown transparent substrate. The substrate 52 is formed of glass. The first electrode 53, which is formed on the substrate 52, injects the electrons into the insulating film 54. The first electrode 53 is formed of Al. The insulating film 54, which is formed on the first electrode 53, is formed of SiOx. The second electrode 55, which is similarly formed on the substrate 52 as the first electrode 53, is formed parallel to the first electrode 53. The second electrode 55 is formed of Au.

The third electrode 56 is formed on the insulating film 54. The third electrode 56 is not formed in the vicinity of the ends of the insulating film 54 and the area of the third electrode 56 is marginally less than the area of the insulating film 54. Due to this, the insulating film 54 includes an exposed portion 59 on the upper surface that is exposed to the outside. The third electrode 56 is formed of Au. The substrate 52, the first electrode 53, the insulating film 54, the second electrode 55, and the third electrode 56 correspond to the respective portions of the electron-emitting device 41 according to the third embodiment. In an intersection 60 where the scan line 57 and the data line 58 intersect, an insulating layer is laminated between the scan line 57 and the data line 58 to prevent a short circuit between wirings. A film can be formed and patterned simultaneously with the insulating film 54 to form the insulating layer. A film can also be formed separately and patterned to form the insulating layer.

The scan line 57 and the data line 58 receive signals according to the input image signals from a not shown processor. The scan line 57 is formed of aluminium, and the data line 58 is formed of Au. The not shown transparent substrate is formed at a fixed distance opposite the substrate 52. A surface of the transparent substrate is coated with a fluorescent material.

A mechanism, which is explained next, is used by the display device 51 to display the image according to the input image signals in a display apparatus 61 that is shown in FIG. 7. A voltage is in advance applied between the first electrode 53 and the transparent substrate. The scan line 57 and the data line 58 receive the signals according to the input image signals and use the signals to apply a voltage in a direction from the second electrode 55 and the third electrode 56 to the first electrode 53. Upon applying the voltage, the electrons are injected into the insulating film 54 from the first electrode 53. Inside the insulating film 54, the electrons are accelerated by the electric field between the first electrode 53 and the third electrode 56 and the accelerated electrons are emitted from the third electrode 56 and the exposed portion 59 towards the transparent substrate. Upon the emitted electrons reaching the transparent substrate, the fluorescent material at the portion where the electrons have reached emits light. The display devices 51 are positioned in the display apparatus 61 in a matrix manner. Each display device 51 of the display apparatus 61 emits light according to the input image signals, thus causing the display apparatus 61 to display the image.

A manufacturing example of the display device 51 is explained with reference to FIGS. 6A and 6B. A film of 100 nm of Al is formed on the washed glass substrate 52 by sputtering and the film is subjected to a normal photolithography process to form the scan line 57 and the first electrode 53 that is connected to the scan line 57. A width of 20 microns and an interval of 20 microns are stipulated for the first electrode 53. Next, a film of 300 nm of SiOx is formed using a sputtering device and the film is patterned to form the insulating film 54 such that the insulating film 54 covers the first electrode 53. Next, a film of 100 nm of Au is formed by sputtering and the film is patterned to form the data line 58, the second electrode 55, and the third electrode 56. A width of 10 microns is stipulated for the second electrode 55 and a width of 10 microns is stipulated for the third electrode 56.

When using the electron emission that penetrates the third electrode 56, the film thickness of less than or equal to 10 nm is desirable for the third electrode 56. If the third electrode 56 and the data line 58 are formed simultaneously, a resistance of the data line 58 increases and is not desirable. Due to this, the third electrode 56 and the data line 58 are formed by separate manufacturing processes and the film thickness of the data line 58 is increased to reduce the resistance of the data line 58. Thus, the second electrode 55 can be formed by using the manufacturing process of the third electrode 56 or the manufacturing process of the data line 58.

The display device 51, which is manufactured under the conditions mentioned earlier, is placed under the vacuum of 1×10⁻⁵ Torr and an accelerating voltage of 1 kilovolt (kV) is applied between the first electrode 53 and the transparent substrate. Upon transmitting the signals according to the input image signals to the scan line 57 and the data line 58, the fluorescent material of the transparent substrate emits light.

The high electron emission efficiency of the display apparatus according to the fourth embodiment causes the fluorescent material of the transparent substrate to emit light even if an amplitude value of the received input image signals is small. Thus, a power consumption of the display apparatus, which includes the display elements formed in the matrix manner, can be reduced.

A fifth embodiment of the present invention is explained with reference to the accompanying drawings. In the fifth embodiment, the electron-emitting device according to the first embodiment is applied to a glow discharge-optical emission device.

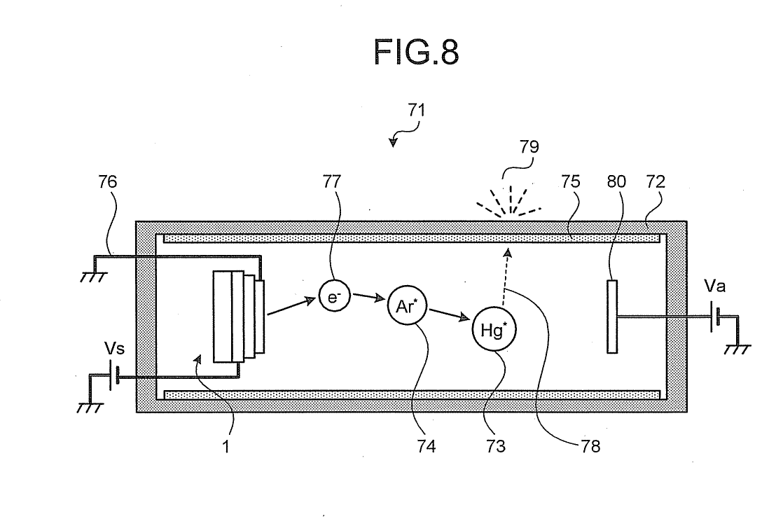

As shown in FIG. 8, a glow discharge-optical emission device 71 encapsulates in a glass tube 72, a minute amount of mercury 73 and argon (Ar) 74 that is an inert gas. A fluorescent film 75 which is formed of a fluorescent material that uses ultraviolet rays to generate visible light is formed inside the glass tube 72. The electron-emitting device 1 is positioned at one end of the glass tube 72. At the time of discharge inception, a direct current (DC) voltage Vs is applied to the electron-emitting device 1 inside the glow discharge-optical emission device 71 from an external source via an extraction lead 76, thus generating the electric field between the first electrode 3, and the second electrode 5 and the third electrode 6. Due to this, accelerated electrons 77 are emitted from the second electrode 5, the third electrode 6, the lower exposed portion 10, and the upper exposed portion 11. Further, the electrons 77 are accelerated and collide with atoms of the argon 74, thus causing ionization of the argon 74. Due to the collision of the electrons 77 and the ionized argon 74, the encapsulated mercury 73 is excited and generates ultraviolet rays 78. The ultraviolet rays 78 excite the fluorescent material of the fluorescent film 75, thus generating visible light 79 from the glow discharge-optical emission device 71. After the discharge inception, the emission of the electrons from the electron-emitting device 1 is not necessitated, and discharge is maintained by applying a DC voltage Va between the second electrode 5 and the third electrode 6, and an opposite electrode (an anode electrode) 80.

Further, the ionized argon 74 collides with the second electrode 5 and the third electrode 6 of the electron-emitting device 1, thus sputtering the second electrode 5 and the third electrode 6. In the commonly used electron-emitting device, because the film thickness, of approximately 10 nm, of the second electrode 5 and the third electrode 6 is thin, the second electrode 5 and the third electrode 6 are sputter-removed during the discharge. However, in the electron-emitting device 1 according to the first embodiment, the film thickness of the second electrode 5 and the third electrode 6 can be increased and a performance of the electron-emitting device 1 is not affected by the film thickness of the second electrode 5 and the third electrode 6. Thus, a life of the glow discharge-optical emission device 71 can be significantly increased.

In the fifth embodiment, the DC voltage is applied between the second electrode and the third electrode, and the opposite electrode (anode electrode). However, an alternating current (AC) voltage can also be applied. After the discharge inception, the emission of the electrons from the electron-emitting device is not necessitated, and the discharge is maintained by applying the AC voltage between the second electrode and the third electrode, and the opposite electrode (anode electrode).

In the glow discharge-optical emission device according to the fifth embodiment, the electrons can be supplied from the electron-emitting device at the time of the discharge inception. Thus, the discharge inception is simplified and a discharge inception voltage can be reduced.

Further, in the glow discharge-optical emission device according to the fifth embodiment, the film thickness of the electrodes which are formed in the upper portion of the electron-emitting device can be increased, thus enabling to prevent a reduction in the electron emission efficiency of the electron-emitting device due to sputter-removal of the electrodes caused by the discharge. Thus, the life of the glow discharge-optical emission device can be significantly increased.

A sixth embodiment of the present invention is explained with reference to the accompanying drawings. In the sixth embodiment, the electron-emitting device 1 according to the first embodiment is applied to an X-ray emitting device.

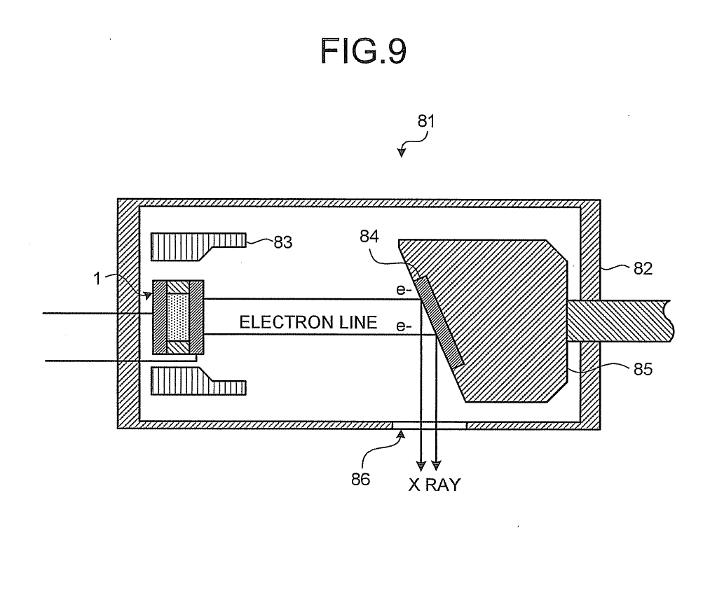

As shown in FIG. 9, an X-ray emitting device 81 includes in a tube 82 that is an airtight container, a convergence tube 83, the electron-emitting device 1, a target 84, and an anode 85. The tube 82 includes an emission window 86. The electron-emitting device 1 is disposed inside the convergence tube 83. A metal such as tungsten or copper is used for the target 84. The electrons, which are emitted into the vacuum from the electron-emitting device 1, are accelerated by the electric field due to the anode 85 and collide with the target 84. X-rays are generated due to the collision. The generated X-rays are emitted outside the tube 82 from the emission window 86.

The X-ray emitting device according to the sixth embodiment uses the electron-emitting device having a high electron emission efficiency, thereby enabling to reduce the power consumption of the X-ray emitting device.

The present invention is not to be limited to the representative embodiments mentioned earlier. The insulating film of SiOx is used in the embodiments mentioned earlier. However, an insulating film can also be used that includes aluminium oxide (Al₂O₃), silicon dioxide (SiO₂), a nano-crystal layer of silicon that is formed by using a process in which polycrystalline silicon layer is electrochemically oxidized in an electrolytic solution, or nano-fine particles of semiconductor material.

In the embodiments mentioned earlier, the first electrode is formed of metal. However, a semiconductor can also be used to form the first electrode. In other words, the present invention can also be applied to a metal-insulator-semiconductor (MOS) type electron-emitting device in which the electrodes in the upper portion are formed of metal and the electrode in the lower portion is formed of a semiconductor.

In the first to the third embodiments, the voltage applied between the first electrode and the second electrode is the same as the voltage applied between the first electrode and the third electrode. However, mutually differing voltages can also be applied and a similar effect can be realized.

In the first to the third embodiments, because the second electrode is disposed to curb the extension of the equipotential surface in the openings (the upper exposed portion and the lower exposed portion), electric potential can be freely set in a range that still enables the second electrode to curb the extension of the equipotential surface. Further, the electric potential of the second electrode can be controlled according to driving conditions of the electron-emitting device and the electron emission efficiency can be controlled.

In the fourth embodiment, the electron-emitting device according to the third embodiment is applied to the display apparatus. However, the electron-emitting device according to the first embodiment or the electron-emitting device according to the second embodiment can also be applied to the display apparatus.

Similarly, in the fifth embodiment, the electron-emitting device according to the first embodiment is applied to the glow discharge-optical emission device. However, the electron-emitting device according to the second embodiment or the electron-emitting device according to the third embodiment can also be applied to the glow discharge-optical emission device.

Similarly, in the sixth embodiment, the electron-emitting device according to the first embodiment is applied to the X-ray emitting device. However, the electron-emitting device according to the second embodiment or the electron-emitting device according to the third embodiment can also be applied to the glow discharge-optical emission device.

According to an embodiment of the present invention, electron emission efficiency of an electron-emitting device can be enhanced.

According to an embodiment of the present invention, a manufacturing process of the electron-emitting device is simplified.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An electron-emitting device comprising:
a first electrode;
an insulating film that is disposed on the first electrode, includes at least one step in an upper surface thereof, and includes a first surface on a lower step portion of the step and a second surface on an upper step portion of the step;
a second electrode that is disposed on the first surface at a distance apart from the step; and
a third electrode that is disposed on the second surface at a distance apart from the step.

2. The device according to claim 1, wherein the first electrode includes at least one opening which is disposed on a lower surface of the insulating film at a position opposite to the second electrode.

3. The device according to claim 2, wherein the opening is further disposed at the position on the lower surface of the insulating film and opposite to a portion of the first surface on which the second electrode is not disposed.

4. The device according to claim 2, wherein the opening is further disposed at the position on the lower surface of the insulating film and opposite to the third electrode.

5. The device according to claim 4, wherein the opening is further disposed at the position on the lower surface of the insulating film and opposite to a portion of the first surface on which the second electrode is not disposed.

6. The device according to claim 1, wherein the insulating film is any one of insulating layers that include silicon oxide, silicon dioxide, aluminium oxide, nano-crystals of silicon formed by using a process where a polycrystalline crystal layer is electrochemically oxidized in an electrolytic solution, and nano-fine particles of a conductive material.

7. An electron-emitting device comprising:
a substrate;
a first electrode that is disposed on the substrate;
a second electrode that is disposed on the substrate in a different area where the first electrode is disposed on the substrate;
an insulating film that is disposed on the first electrode; and
a third electrode that is disposed on the insulating film, wherein
the third electrode is disposed at an inner side from an end of an upper surface of the insulating film and the end is exposed.

8. The device according to claim 7, wherein the insulating film is any one of insulating layers that include silicon oxide, silicon dioxide, aluminium oxide, nano-crystals of silicon formed by using a process where a polycrystalline silicon layer is electrochemically oxidized in an electrolytic solution, and nano-fine particles of a conductive material.

9. A display apparatus comprising:
an electron-emitting device that emits electrons;
a scan line and a data line that transmit input image signals to the electron-emitting device; and
a transparent substrate that is positioned opposite to the electron-emitting device at a predetermined distance apart therefrom, and provides a fluorescent material on a surface thereof, wherein
the electron-emitting device includes
a first electrode,
an insulating film that is formed on the first electrode, includes at least one step in an upper surface, and includes a first surface on a lower step portion and a second surface on an upper step portion of the step,
a second electrode that is formed on the first surface at a distance apart from the step, and
a third electrode that is formed on the second surface at a distance apart from the step.

10. The apparatus according to claim 9, wherein the first electrode includes at least one opening which is disposed on a lower surface of the insulating film at a position opposite to the second electrode.

11. The apparatus according to claim 10, wherein the opening is further disposed at the position on the lower surface of the insulating film and opposite to a portion of the first surface on which the second electrode is not disposed.

12. The apparatus according to claim 10, wherein the opening is further disposed at the position on the lower surface of the insulating film and opposite to the third electrode.

13. The apparatus according to claim 12, wherein the opening is further disposed at the position on the lower surface of the insulating film and opposite to a portion of the first surface on which the second electrode is not disposed.

14. A display apparatus comprising:
an electron-emitting device that emits electrons;
a scan line and a data line that transmit input image signals to the electron-emitting device; and
a transparent substrate that is positioned opposite to the electron-emitting device at a predetermined distance apart therefrom, and provides a fluorescent material on a surface thereof, wherein
the electron-emitting device includes
a substrate,
a first electrode that is disposed on the substrate,
a second electrode that is disposed on the substrate in a different area where the first electrode is disposed on the substrate,
an insulating film that is disposed on the first electrode, and
a third electrode that is disposed on the insulating film, wherein
the third electrode is disposed at an inner side from an end of an upper surface of the insulating film and the end is exposed.
